(19) United States
(12) Patent Application Publication
(10) Pub. No.: US 2015/0269672 A1
(43) Pub. Date: Sep. 24, 2015

(54) TRADING PLATFORM CURRENTLY KNOWN AS ALPHAMETRICS AND IT'S ACCOMPANYING API (APPLICATION PROGRAMMING INTERFACE) FOR ITS USAGE; TO INCLUDE A VOICE RECOGNITION SOFTWARE PLATFORM DESIGNED TO AGGREGATE END OF DAY ORDER IMBALANCE SENTIMENT FOR NYSE TRADED ISSUES

(71) Applicant: HYBRID TITAN MANAGEMENT, LLC, Charlotte, NC (US)

(72) Inventor: PRASHANT BHUYAN, NEW YORK, NY (US)

(73) Assignee: HYBRID TITTAN MANAGEMENT, LLC, Charlotte, NC (US)

(21) Appl. No.: 14/222,173

(22) Filed: Mar. 21, 2014

(51) Int. Cl. G06Q 40/04; G10L 13/00

(52) U.S. Cl. CPC G06Q 40/04; G10L 13/00

(57) ABSTRACT

A method performed in a system incorporating a processing unit, an audio capture device, a network interface, a data storage system and a memory, the method being performed in connection with an audio signal containing spoken market imbalance data, the method involving: capturing the audio signal containing spoken market imbalance data using the audio capture device; performing text-to-speech conversion of the captured audio signal containing spoken market imbalance data to obtain textual representation of the audio signal containing spoken market imbalance data; performing parsing of the textual representation of the audio signal containing spoken market imbalance data to obtain parsed textual market imbalance data; performing filtering of the parsed textual market imbalance data to obtain filtered textual market imbalance data; storing the filtered textual market imbalance data in the data storage system; and disseminating the filtered textual market imbalance data.

### BACKGROUND OF THE INVENTION

1. Technical Field

The disclosed embodiments relate in general to systems and methods for assisting with trading various securities and other issues and, more specifically, to systems and methods for implementing a trading platform and it's accompanying API (application programming interface) for its usage to include a voice recognition software platform designed to aggregate end of day order imbalance sentiment for exchange-traded issues.

2. Description of the Related Art

As would be appreciated by persons of ordinary skill in the art, the state of the available conventional trading platforms for serious algorithmic traders is very weak. Not only do these platforms not offer low latency multi-asset class support but they also lack robust backtesting and sophisticated execution and routing algorithms. The conventional “off-the-shelf” trading platforms were tailored for manual traders with a budget of less than $500 a month. These platforms failed to evolve into multi-asset class low latency solutions for professional algorithmic traders as manual traders themselves evolved into more sophisticated program traders. Custom solutions for serious algorithmic traders could cost many thousands of dollars a month or even more.

Therefore, new and improved industrial strength tools for a new generation of professional automated trader focused on automation and data science are needed.

### SUMMARY OF THE INVENTION

The embodiments described herein are directed to methods and systems that substantially obviate one or more of the above and other problems associated with conventional methods for assisting with securities trading.

In accordance with one aspect of the embodiments described herein, there is provided a computer-implemented method performed in a computerized system incorporating a central processing unit, an audio capture device, a network interface, a data storage system and a memory, the computer-implemented method being performed in connection with an audio signal containing spoken market imbalance data, the computer-implemented method involving: capturing the audio signal containing spoken market imbalance data using the audio capture device; using the central processing unit to perform text-to-speech conversion of the captured audio signal containing spoken market imbalance data to obtain textual representation of the audio signal containing spoken market imbalance data; using the central processing unit to perform parsing of the textual representation of the audio signal containing spoken market imbalance data to obtain parsed textual market imbalance data; using the central processing unit to perform filtering of the parsed textual market imbalance data to obtain filtered textual market imbalance data; storing the filtered textual market imbalance data in the data storage system; and using the network interface to disseminate the filtered textual market imbalance data.

In one or more embodiments, the data storage system comprises a relational database.

In one or more embodiments, the audio capture device is a microphone.

In one or more embodiments, the text-to-speech conversion is performed using Dragon Naturally Software Development Kit.

In one or more embodiments, the filtered textual market imbalance data is disseminated using an application programming interface (API).

In one or more embodiments, the filtered textual market imbalance data is disseminated using a GUI (graphical user interface) icon named the MSM (Market Sentiment Meter).

In accordance with another aspect of the embodiments described herein, there is provided a non-transitory computer-readable medium embodying a set of computer-executable instructions, which, when executed in a computerized system incorporating a central processing unit, an audio capture device, a network interface, a data storage system and a memory in connection with an audio signal containing spoken market imbalance data, cause the computerized system to perform a method involving: capturing the audio signal containing spoken market imbalance data using the audio capture device; using the central processing unit to perform text-to-speech conversion of the captured audio signal containing spoken market imbalance data to obtain textual representation of the audio signal containing spoken market imbalance data; using the central processing unit to perform parsing of the textual representation of the audio signal containing spoken market imbalance data to obtain parsed textual market imbalance data; using the central processing unit to perform filtering of the parsed textual market imbalance data to obtain filtered textual market imbalance data; storing the filtered textual market imbalance data in the data storage system; and using the network interface to disseminate the filtered textual market imbalance data.

In one or more embodiments, the data storage system comprises a relational database.

In one or more embodiments, the audio capture device is a microphone.

In one or more embodiments, the text-to-speech conversion is performed using Dragon Naturally Software Development Kit.

In one or more embodiments, the filtered textual market imbalance data is disseminated using an application programming interface (API).

In one or more embodiments, the filtered textual market imbalance data is disseminated using a GUI (graphical user interface) icon named the MSM (Market Sentiment Meter).

In accordance with yet another aspect of the embodiments described herein, there is provided a computerized system incorporating a central processing unit, an audio capture device, a network interface, a data storage system and a memory storing a set of instructions executable in connection with an audio signal containing spoken market imbalance data, the set of instructions containing instructions for: capturing the audio signal containing spoken market imbalance data using the audio capture device; using the central processing unit to perform text-to-speech conversion of the captured audio signal containing spoken market imbalance data to obtain textual representation of the audio signal containing spoken market imbalance data; using the central processing unit to perform parsing of the textual representation of the audio signal containing spoken market imbalance data to obtain parsed textual market imbalance data; using the central processing unit to perform filtering of the parsed textual market imbalance data to obtain filtered textual market imbalance data; storing the filtered textual market imbalance data in the data storage system; and using the network interface to disseminate the filtered textual market imbalance data.

In one or more embodiments, the data storage system comprises a relational database.

In one or more embodiments, the audio capture device is a microphone.

In one or more embodiments, the text-to-speech conversion is performed using Dragon Naturally Software Development Kit.

In one or more embodiments, the filtered textual market imbalance data is disseminated using an application programming interface (API).

In one or more embodiments, the filtered textual market imbalance data is disseminated using a GUI (graphical user interface) icon named the MSM (Market Sentiment Meter).

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive system for aggregating and disseminating market imbalance data.

FIG. 2 illustrates an exemplary embodiment of imbalance data aggregation methodology performed in connection with an alpha metrics trading platform.

FIG. 3 illustrates an exemplary embodiment of an operating sequence of the imbalance data capture, processing and managing application.

FIG. 4 is a block diagram that illustrates an embodiment of a computer system upon which various embodiments of the inventive concepts described herein may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the invention, there is provided a low latency cross asset trading platform for hybrid manual and algorithmic traders. The aforesaid platform serves as a hub for various data scientific components that together, give individual traders and retail traders the tools necessary to compete with sophisticated HFT counterparties.

The problem that one or more embodiments of the invention seek to address relates to the democratization of market structure. Currently, only a small segment of the market has access to trading technology and tools needed to compete in electronic trading markets. Due to high barriers of entry which include high costs of hardware and data as well as a need for sophisticated programming and statistical research skills the majority of investors and traders cannot compete against advanced algorithms in today's financial markets. One or more embodiments of the invention help to solve this problem by bringing together research, development and implementation modules into one low latency cross asset trading platform for professional and retail traders and investors.

Only the exchange, such as NYSE, has access to opening and closing imbalances. The only way to get a clear concise picture of what the opening and closing auctions look like is at the times the NYSE publishes their data. Normally, the data is published in accordance with the following schedule:

1. Opening Imbalance messages are disseminated every 5 minutes between 8:30 am EST and 9:00 am EST.

2. Opening Imbalance messages are disseminated every 1 minute between 9:00 am EST and 9:20 am EST.

3. Opening Imbalance messages are disseminated every 15 second between 9:20 am EST and the opening, or 9:35 am, whichever comes first.

4. Continuous Book Clearing publication 2 minutes prior to the open at approximately 9:28 am.

5. Closing Imbalance messages are disseminated every 5 seconds between 3:45 pm EST and 4:00 pm EST (or until Market close on early closing days).

In accordance with one or more embodiments, the imbalance data is being manually captured through relationships with floor brokers operating on the exchange floor. To this end, audio capture devices coupled with voice recognition software are installed in floor brokers booths to capture voice read outs of the data by the brokers. After capture and digitization, the data is aggregated and stored for future retrieval. In one or more embodiments, certain back testing tools are applied to the aggregated data to filter the data. After that, the captured data is disseminated using a GUI (graphical user interface) icon named the MSM (Market Sentiment Meter) to the general retail subscribers or via an API to more sophisticated subscribers.

As would be appreciated by persons or ordinary skill in the art, the aforesaid voice recognition software is one of the democratized components of the aforesaid AlphaMetrics platform. It uses voice recognition to capture unstructured un-unused data and extracts from it statistically valuable insight that pushes value through the AlphaMetrics platform to the end users. In one aspect, the voice recognition software captures publicly available unstructured market-related data from the floor brokers and the remaining system components structure the data to a form usable to brokers (traders).

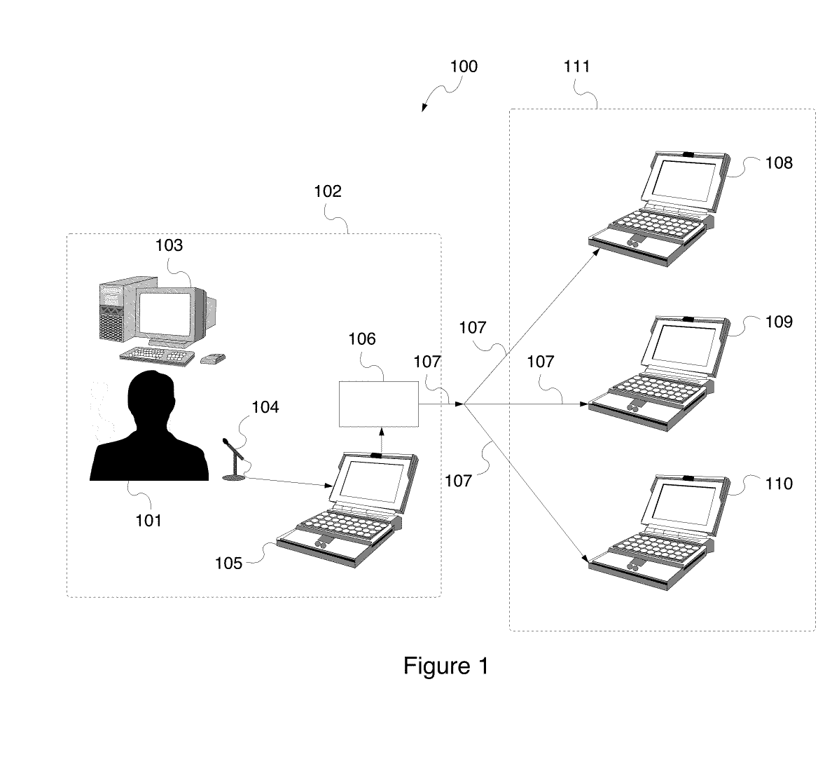

FIG. 1 illustrates an exemplary embodiment of the inventive system 100 for aggregating and disseminating market imbalance data. Trading clerk 101 operating on the exchange floor 102 receives the MOC imbalance data using the exchange's data display 102. The trading clerk 101 reads aloud the received imbalance data, which is captured by the audio capture device 104 coupled to the broker workstation 105. The broker workstation 105 executes speech to text conversion application 106. In one or more embodiments, the speech to text conversion application 106 is implemented based on Dragon Naturally Software Development Kit (SDK), well known to persons of ordinary skill in the art. The audio signal captured by the audio capture device 104 is converted to textual representation 107 in the aforesaid speech to text conversion application 106 executing in the broker workstation 105. In one or more embodiments, an imbalance data aggregation application (not shown) executing on the broker workstation 105 aggregates the MOC imbalance data converted to text. The MOC imbalance data converted to text 107 is subsequently transmitted from the broker workstation 105 to a database server/client 108, database server/client 109 and database server/client 110. As would be appreciated by persons of ordinary skill in the art, there can be any number of database server/clients receiving the aggregated textual imbalance data 107.

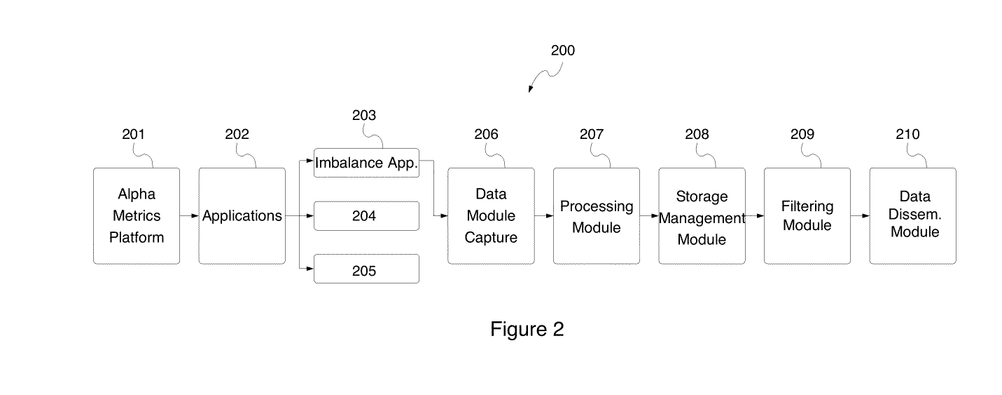

FIG. 2 illustrates an exemplary embodiment of imbalance data aggregation methodology 200 performed in connection with an alpha metrics trading platform 201. In one or more embodiments, the alpha metrics trading platform 201 is configured to execute one or more applications 202, which may include the inventive imbalance data capture, processing and managing application 203, as well as applications 204 and 205. In one or more embodiments, the imbalance data managing application 203 incorporates audio data capture module 206 configured to capture and digitize the audio signal generated by the audio capture device 104 shown in FIG. 1. The imbalance data capture, processing and managing application 203 further incorporates a processing module 207 configured to receive the captures audio data from the data capture module 206 and to process the receive audio data by converting it to text using the speech to text conversion process, well known to persons of ordinary skill in the art. The imbalance data capture, processing and managing application 203 further incorporates a data storage management module 208, which stores the textual imbalance data in a database or other suitable storage system. The imbalance data capture, processing and managing application 203 further incorporates a data parsing and filtering module 209 configured to parse, filter and otherwise process the textual imbalance data. Finally, the imbalance data capture, processing and managing application 203 further incorporates an imbalance data dissemination module 210 configured to disseminate the textual imbalance data to customers using an API of other via suitable means.

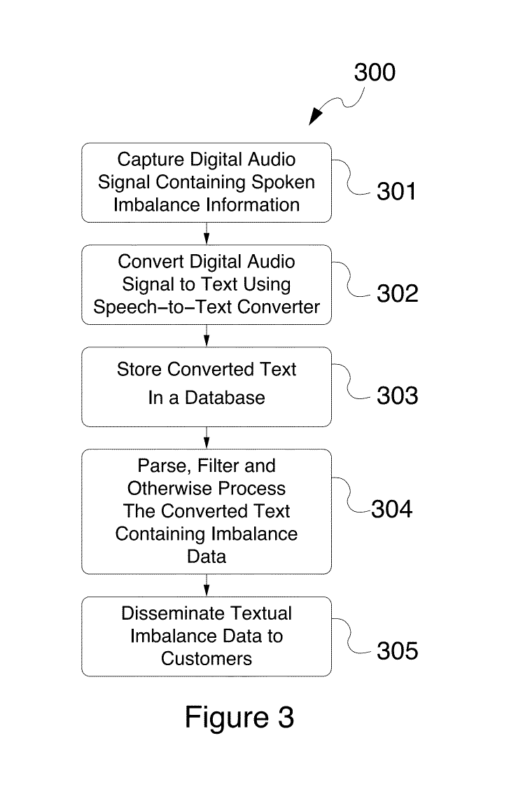

FIG. 3 illustrates an exemplary embodiment of an operating sequence 300 of the imbalance data capture, processing and managing application 203. First, at step 301, the digital audio signal containing the spoken imbalance information is captured. At step 302, the captured digital audio signal containing the spoken imbalance information is processed by converting it to text using the speech to text conversion process, well known to persons of ordinary skill in the art. At step 303, the resulting textual representation of the captured digital audio signal containing the spoken imbalance information is stored in a database of other suitable storage. At step 304, the textual imbalance data is parsed, filtered and otherwise processed. Finally, at step 305, the processed textual imbalance data is disseminated to customers using an API of other via suitable means.

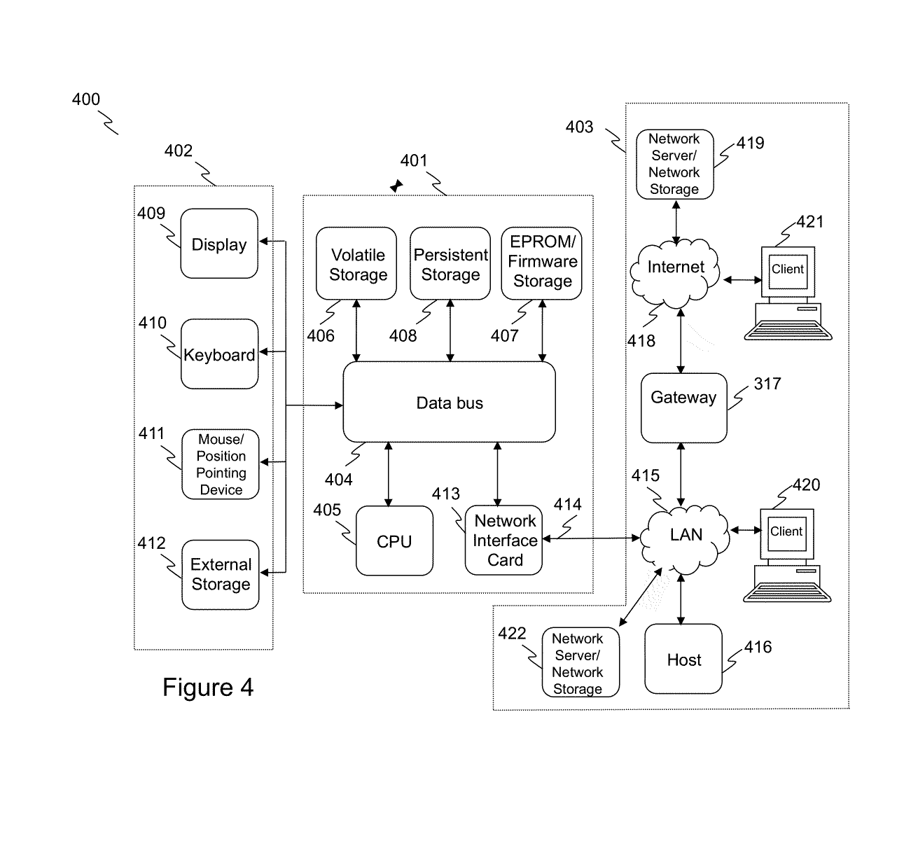

FIG. 4 is a block diagram that illustrates an embodiment of a computer system 400 upon which various embodiments of the inventive concepts described herein may be implemented. The system 400 includes a computer platform 401, peripheral devices 402 and network resources 403.

The computer platform 401 may include a data bus 404 or other communication mechanism for communicating information across and among various parts of the computer platform 401, and a processor 405 coupled with bus 404 for processing information and performing other computational and control tasks. Computer platform 401 also includes a volatile storage 406, such as a random access memory (RAM) or other dynamic storage device, coupled to bus 404 for storing various information as well as instructions to be executed by processor 405, including the software application for proxy detection described above. The volatile storage 406 also may be used for storing temporary variables or other intermediate information during execution of instructions by processor 405. Computer platform 401 may further include a read only memory (ROM or EPROM) 407 or other static storage device coupled to bus 404 for storing static information and instructions for processor 405, such as basic input-output system (BIOS), as well as various system configuration parameters. A persistent storage device 408, such as a magnetic disk, optical disk, or solid-state flash memory device is provided and coupled to bus 404 for storing information and instructions.

Computer platform 401 may be coupled via bus 404 to a touch-sensitive display 409, such as a cathode ray tube (CRT), plasma display, or a liquid crystal display (LCD), for displaying information to a system administrator or user of the computer platform 401. An input device 410, including alphanumeric and other keys, is coupled to bus 404 for communicating information and command selections to processor 405. Another type of user input device is cursor control device 411, such as a mouse, a trackball, or cursor direction keys for communicating direction information and command selections to processor 405 and for controlling cursor movement on touch-sensitive display 409. This input device typically has two degrees of freedom in two axes, a first axis (e.g., x) and a second axis (e.g., y), that allows the device to specify positions in a plane. To detect user's gestures, the display 409 may incorporate a touchscreen interface configured to detect user's tactile events and send information on the detected events to the processor 405 via the bus 404.

An external storage device 412 may be coupled to the computer platform 401 via bus 404 to provide an extra or removable storage capacity for the computer platform 401. In an embodiment of the computer system 400, the external removable storage device 412 may be used to facilitate exchange of data with other computer systems.

The invention is related to the use of computer system 400 for implementing the techniques described herein. In an embodiment, the inventive system may reside on a machine such as computer platform 401. According to one embodiment of the invention, the techniques described herein are performed by computer system 400 in response to processor 405 executing one or more sequences of one or more instructions contained in the volatile memory 406. Such instructions may be read into volatile memory 406 from another computer-readable medium, such as persistent storage device 408. Execution of the sequences of instructions contained in the volatile memory 406 causes processor 405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 405 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 408. Volatile media includes dynamic memory, such as volatile storage 406.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 405 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 404. The bus 404 carries the data to the volatile storage 406, from which processor 405 retrieves and executes the instructions. The instructions received by the volatile memory 406 may optionally be stored on persistent storage device 408 either before or after execution by processor 405. The instructions may also be downloaded into the computer platform 401 via Internet using a variety of network data communication protocols well known in the art.

The computer platform 401 also includes a communication interface, such as network interface card 413 coupled to the data bus 404. Communication interface 413 provides a two-way data communication coupling to a network link 414 that is coupled to a local network 415. For example, communication interface 413 may be an integrated services digital network (ISDN) card or a modem to provide a data communication connection to a corresponding type of telephone line. As another example, communication interface 413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 413 sends and receives electrical, electromagnetic or optical signals that carry digital data streams representing various types of information.

Network link 414 typically provides data communication through one or more networks to other network resources. For example, network link 414 may provide a connection through local network 415 to a host computer 416, or a network storage/server 422. Additionally or alternatively, the network link 414 may connect through gateway/firewall 417 to the wide-area or global network 418, such as an Internet. Thus, the computer platform 401 can access network resources located anywhere on the Internet 418, such as a remote network storage/server 419. On the other hand, the computer platform 401 may also be accessed by clients located anywhere on the local area network 415 and/or the Internet 418. The network clients 420 and 421 may themselves be implemented based on the computer platform similar to the platform 401.

Local network 415 and the Internet 418 both use electrical, electromagnetic or optical signals that carry digital data streams. The signals through the various networks and the signals on network link 414 and through communication interface 413, which carry the digital data to and from computer platform 401, are exemplary forms of carrier waves transporting the information.

Computer platform 401 can send messages and receive data, including program code, through the variety of network(s) including Internet 418 and LAN 415, network link 415 and communication interface 413. In the Internet example, when the system 401 acts as a network server, it might transmit a requested code or data for an application program running on client(s) 420 and/or 421 through the Internet 418, gateway/firewall 417, local area network 415 and communication interface 413. Similarly, it may receive code from other network resources.

The received code may be executed by processor 405 as it is received, and/or stored in persistent or volatile storage devices 408 and 406, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, pearl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for capturing, processing, managing and disseminating market imbalance data. It is intended that the specification and examples be considered as exemplary only, with a true scope and spirit of the invention being indicated by the following claims.

What is claimed is:

1. A computer-implemented method performed in a computerized system comprising a central processing unit, an audio capture device, a network interface, a data storage system and a memory, the computer-implemented method being performed in connection with an audio signal comprising spoken market imbalance data, the computer-implemented method comprising:
a. capturing the audio signal containing spoken market imbalance data using the audio capture device;
b. using the central processing unit to perform text-to-speech conversion of the captured audio signal containing spoken market imbalance data to obtain textual representation of the audio signal containing spoken market imbalance data;
c. using the central processing unit to perform parsing of the textual representation of the audio signal containing spoken market imbalance data to obtain parsed textual market imbalance data;
d. using the central processing unit to perform filtering of the parsed textual market imbalance data to obtain filtered textual market imbalance data;
e. storing the filtered textual market imbalance data in the data storage system; and
f. using the network interface to disseminate the filtered textual market imbalance data.

2. The computer-implemented method of claim 1, wherein the data storage system comprises a relational database.

3. The computer-implemented method of claim 1, wherein the audio capture device is a microphone.

4. The computer-implemented method of claim 1, wherein the text-to-speech conversion is performed using Dragon Naturally Software Development Kit.

5. The computer-implemented method of claim 1, wherein the filtered textual market imbalance data is disseminated using an application programming interface (API).

6. The computer-implemented method of claim 1, wherein the filtered textual market imbalance data is disseminated using a graphical user interface icon.

7. A non-transitory computer-readable medium embodying a set of computer-executable instructions, which, when executed in a computerized system comprising a central processing unit, an audio capture device, a network interface, a data storage system and a memory in connection with an audio signal comprising spoken market imbalance data, cause the computerized system to perform a method comprising:
a. capturing the audio signal containing spoken market imbalance data using the audio capture device;
b. using the central processing unit to perform text-to-speech conversion of the captured audio signal containing spoken market imbalance data to obtain textual representation of the audio signal containing spoken market imbalance data;
c. using the central processing unit to perform parsing of the textual representation of the audio signal containing spoken market imbalance data to obtain parsed textual market imbalance data;
d. using the central processing unit to perform filtering of the parsed textual market imbalance data to obtain filtered textual market imbalance data;
e. storing the filtered textual market imbalance data in the data storage system; and
f. using the network interface to disseminate the filtered textual market imbalance data.

8. The non-transitory computer-readable medium of claim 7, wherein the data storage system comprises a relational database.

9. The non-transitory computer-readable medium of claim 7, wherein the audio capture device is a microphone.

10. The non-transitory computer-readable medium of claim 7, wherein the text-to-speech conversion is performed using Dragon Naturally Software Development Kit.

11. The non-transitory computer-readable medium of claim 7, wherein the filtered textual market imbalance data is disseminated using an application programming interface (API).

12. The non-transitory computer-readable medium of claim 7, wherein the filtered textual market imbalance data is disseminated using a graphical user interface icon.

13. A computerized system comprising a central processing unit, an audio capture device, a network interface, a data storage system and a memory storing a set of instructions executable in connection with an audio signal comprising spoken market imbalance data, the set of instructions comprising instructions for:
a. capturing the audio signal containing spoken market imbalance data using the audio capture device;
b. using the central processing unit to perform text-to-speech conversion of the captured audio signal containing spoken market imbalance data to obtain textual representation of the audio signal containing spoken market imbalance data;
c. using the central processing unit to perform parsing of the textual representation of the audio signal containing spoken market imbalance data to obtain parsed textual market imbalance data;
d. using the central processing unit to perform filtering of the parsed textual market imbalance data to obtain filtered textual market imbalance data;
e. storing the filtered textual market imbalance data in the data storage system; and
f. using the network interface to disseminate the filtered textual market imbalance data.

14. The computerized system of claim 13, wherein the data storage system comprises a relational database.

15. The computerized system of claim 13, wherein the audio capture device is a microphone.

16. The computerized system of claim 13, wherein the text-to-speech conversion is performed using Dragon Naturally Software Development Kit.

17. The computerized system of claim 13, wherein the filtered textual market imbalance data is disseminated using an application programming interface (API).

18. The computerized system of claim 13, wherein the filtered textual market imbalance data is disseminated using a graphical user interface icon.
